(19) United States
(12) Patent Application Publication
(10) Pub. No.: US 2011/0103875 A1
(43) Pub. Date: May 5, 2011

(54) RETRACTABLE PUSH BUTTON PEN

(76) Inventor: Shih-Yuan HUANG, Taipei County (TW)

(21) Appl. No.: 12/611,574

(22) Filed: Nov. 3, 2009

(51) Int. Cl. B43K 24/08

(52) U.S. Cl. 401/104

(57) ABSTRACT

A retractable push button pen includes a barrel, a pen refill, which has a refill body with hooks at the front side and a writing tip extended out of the front side of the refill body, an extending and retracting mechanism formed of a slide, a limiter and a spring member and received inside the barrel around the writing tip received in the barrel, and a press-control mechanism formed of an absorption rod, which is connected to the writing tip to supply an ink, a cylindrical cap holding the absorption rod and extending out of the rear side of the barrel for pressing by a user to move the writing tip out of the barrel for writing and a pen clip, which has a positioning protrusion engageable into the barrel to lock the pen refill in the extended position and a press portion for pressing by a user to unlock the positioning protrusion from the pen refill.

### BACKGROUND OF THE INVENTION

1. Field of the Invention

The present invention relates to writing apparatus and more particularly, to a retractable push button pen, which has a press-control mechanism provided at the rear side of the pen barrel such that the user can press a cylindrical cap of the press-control mechanism to extend out the writing tip for writing and then press a pen clip of the press-control mechanism to retract the writing tip after an use of the pen.

2. Description of the Related Art

A conventional ink pen has a writing tip that absorbs an ink from an ink refill for writing. However, because the writing tip is exposed to the air, the ink contained in the writing tip may be dried, causing the writing tip unable to guide out the ink from the ink refill smoothly. To avoid quick change of the ink into vapor, an ink pen may have a plug fastened to the rear side of the pen barrel and a pen cap detachably capped on the front side of the pen barrel.

However, using a pen cap to prevent quick drying of the ink is not a practical way. Before each use of the pen, the user must remove the pen cap from the pen barrel. After each use of the pen, the user must cap the pen cap onto the front side of the pen barrel again. If the user forgets to cap the pen cap after each use of the pen, the ink in the writing tip will be changed into vapor soon. Further, frequently removing the pen cap from the pen barrel and capping the pen cap onto the pen barrel will cause the pen cap to wear soon. When the pen cap starts to wear, the pen cap may drop from the pen barrel accidentally.

Therefore, it is desirable to provide an ink pen that eliminates the aforesaid problems.

### SUMMARY OF THE INVENTION

The present invention has been accomplished under the circumstances in view. It is therefore the main object of the present invention to provide a retractable push button pen, which eliminates the aforesaid problems.

To achieve this and other objects of the present invention, the retractable push button pen comprises a pen body formed of a barrel and a pen refill, an extending and retracting mechanism and a press-control mechanism. The pen refill comprises a refill body with a locating block at the rear side, and a writing tip fastened to front side of the refill body. The press-control mechanism comprises a cylindrical cap, an absorption rod extended out of the front side of the cylindrical cap and inserted into the refill body to supply an ink to the writing tip, and a pen clip. When the user presses the cylindrical cap, the writing tip is extended out of the barrel for writing, a spring member of the extending and retracting mechanism is compressed, and the pen clip is engaged with the locating block of the refill body to lock the pen refill in the extended position. When the user presses a press portion of the pen clip, the pen clip is disengaged from the locating block of the refill body, enabling the spring member to return the pen refill. Thus, the writing tip is kept inside the barrel, avoiding direct contact of the writing tip with the outside air. Therefore, the ink contained in the writing tip will not be easily changed into vapor when the retractable push button pen is not used.

Further, during the assembly process of the retractable push button pen, slide, limiter and spring member of the extending and retracting mechanism are mounted on the front side of the pen refill, the absorption rod and cylindrical cap of the press-control mechanism are mounted in the rear side of the pen refill, and then the pen refill with the extending and retracting mechanism and the press-control mechanism are inserted into the accommodation space of the barrel. Therefore, the assembly process of the retractable push button pen can be done conveniently and quickly.

Further, the pen clip comprises a coupling tube sleeved onto the cylindrical cap of the press-control mechanism. Therefore, frequently operating the press portion does not cause disconnection of the pen clip from the pen body. Further, the cylindrical cap gives a support to the coupling tube of the pen clip, and therefore the pen clip will not be forced to vibrate when the user presses the press portion of the pen clip.

Further, a strip spring is set between the press portion of the pen clip and the coupling tube so that the pen clip is returned to its former position automatically when the applied pressure is released from the press portion of the pen clip.

Further, a spring member is stopped between the locating block of the pen refill and a front stop edge of the coupling tube of the pen clip. By means of buffering of the spring member between the pen refill and the coupling tube, the locating block of the pen refill is prohibited from striking against the connection lug of the pen clip during return stroke of the pen refill, avoiding noise or wear damage.

### BRIEF DESCRIPTION OF THE DRAWINGS

FIG. 1 is an elevational view of a retractable push button pen in accordance with the present invention.

FIG. 2 is an exploded view of the retractable push button pen in accordance with the present invention.

FIG. 3 is an exploded view of a part of the present invention, showing the relationship between the barrel of the pen body and the pen clip of the press-control mechanism.

FIG. 4 is a sectional side view of the retractable push button pen in accordance with the present invention.

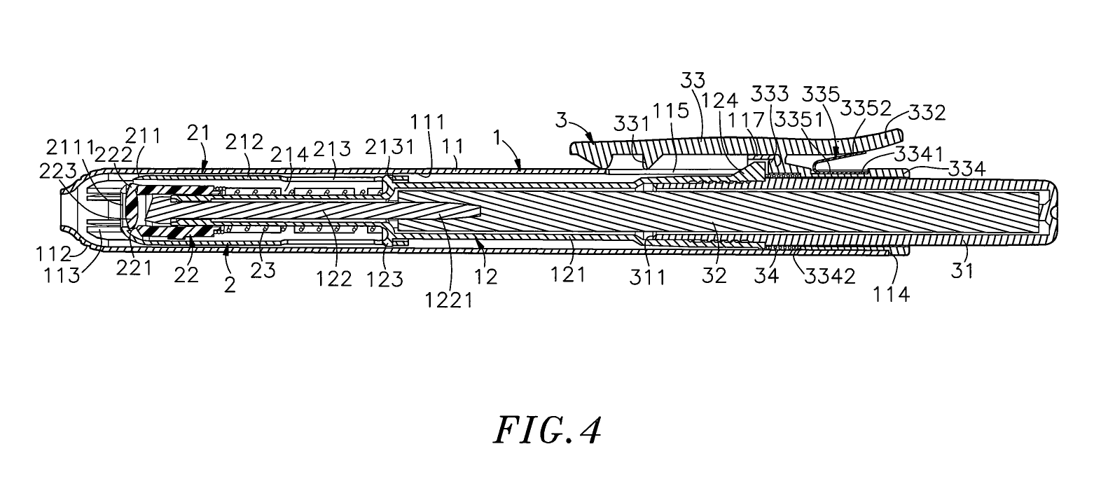

FIG. 5 is an enlarged view of a part of FIG. 4, showing the detailed arrangement of the press-control mechanism in the rear side of the pen body.

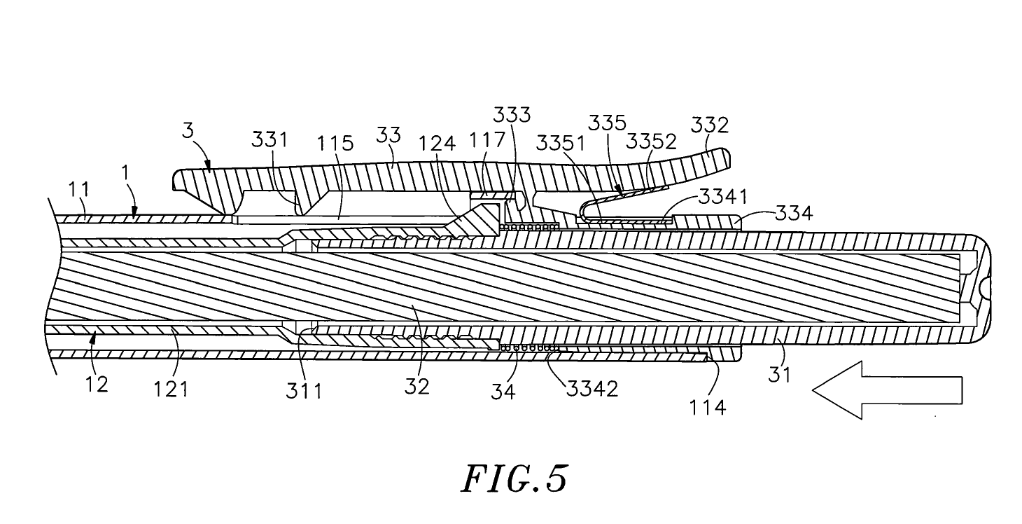

FIG. 6 corresponds to FIG. 5, showing the cylindrical cap of the press-control mechanism pressed and the positioning protrusion stopped against the locating block of the pen refill.

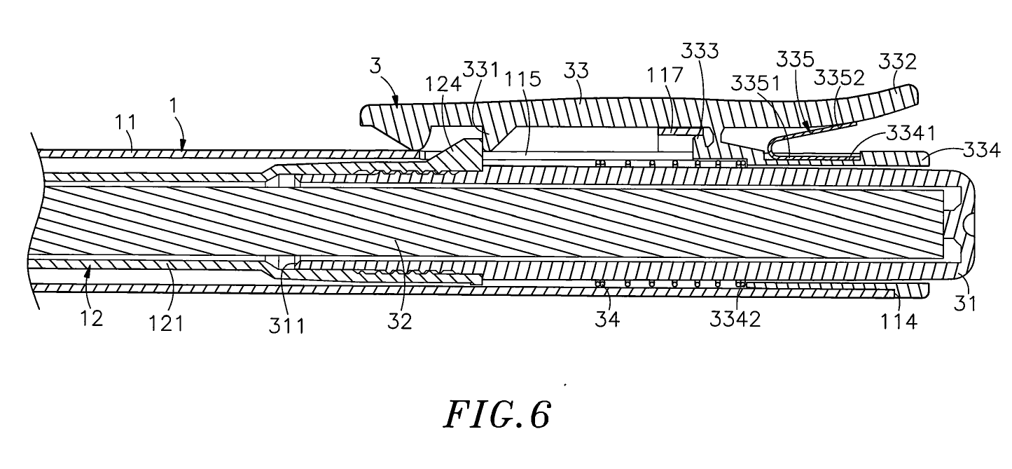

FIG. 7 corresponds to FIG. 6, showing the press portion of the pen clip pressed and the locating block of the pen refill released from the constraint of the positioning protrusion of the pen clip.

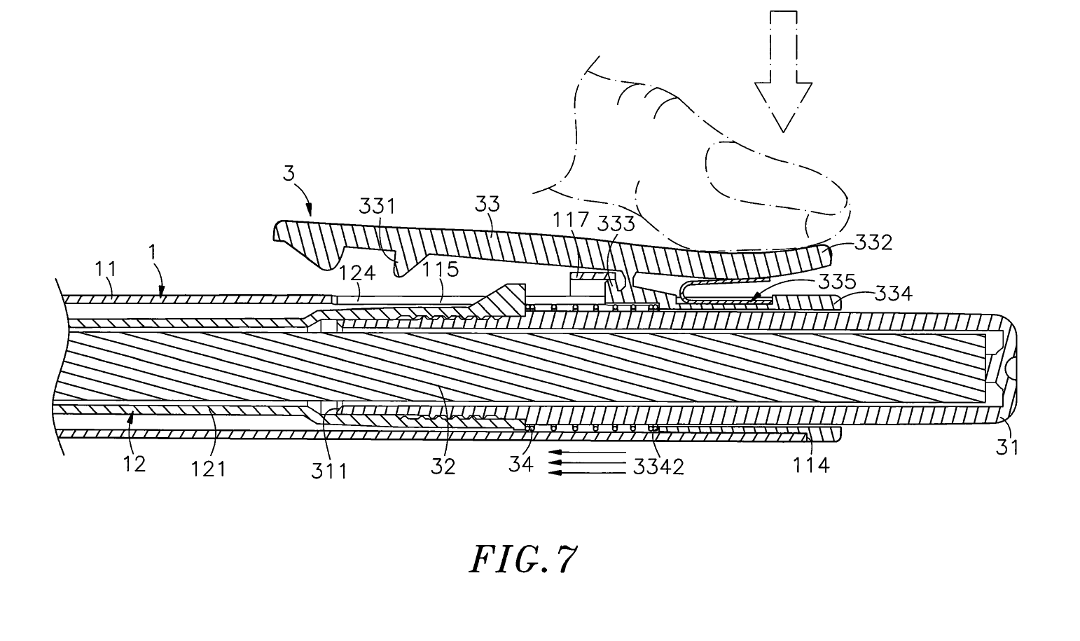

FIG. 8 is a schematic sectional view of the present invention, showing the retractable push button pen fastened to the breast pocket of a shirt.

### DETAILED DESCRIPTION OF THE PREFERRED EMBODIMENT

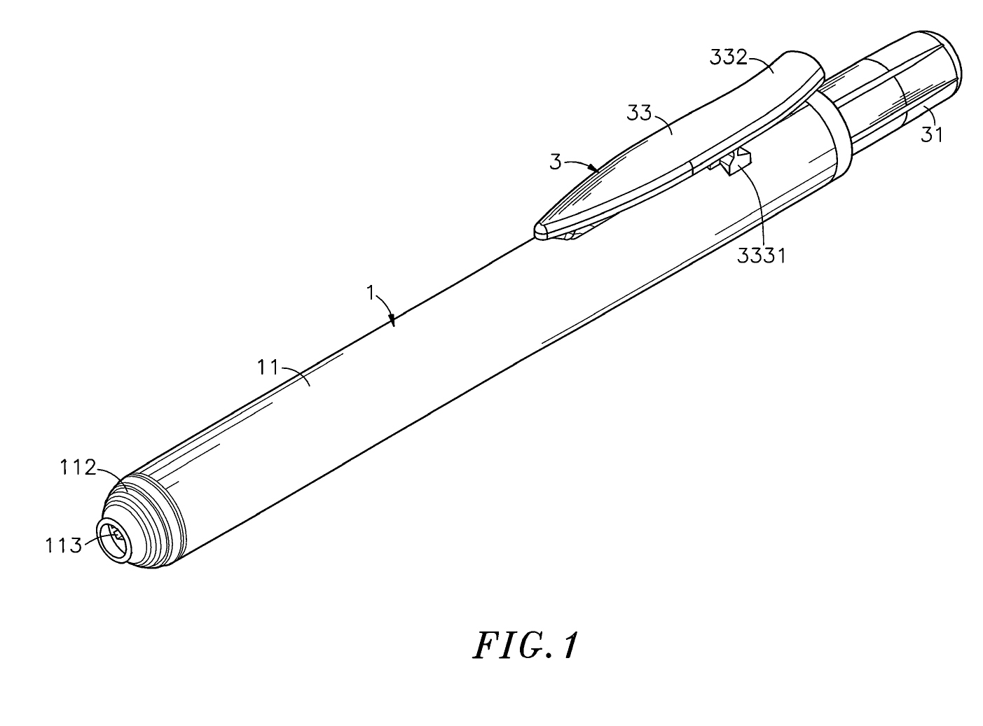

Referring to FIGS. 1˜4 a retractable push button pen in accordance with the present invention is shown comprising a pen body 1, an extending and retracting mechanism 2 and a press-control mechanism 3.

The pen body 1 comprises a barrel 11 and a pen refill 12. The barrel 11 comprises an accommodation space 111 longitudinally extending through front and rear ends thereof, a front end portion 112 located on the front end, a plurality of positioning ribs 113 located on the inside wall of the front end portion 112 inside the accommodation space 111, a rear end portion 114 located on the rear end, a longitudinal sliding slot 115 cut through the peripheral wall of the rear end portion 114 in communication with the accommodation space 111, two mounting holes 116 cut through the peripheral wall of the rear end portion 114 at two opposite lateral sides relative to the longitudinal sliding slot 115 and a protruding block 117 raised from the peripheral wall of the rear end portion 114 and bridging the longitudinal sliding slot 115 on the middle. The pen refill 12 is received in the accommodation space 111 of the pen body 1, comprising a refill body 121, a refill chamber 120 defined in the hollow refill body 121, a writing tip 122 having a rear plug end 1221 tightly inserted through the front side of the refill body 121 into the refill chamber 120, two hooks 123 bilaterally backwardly protruded from the periphery of the front side of the refill body 121 and a beveled locating block 124 protruded from the periphery of the rear side of the refill body 121 for stopping against a spring member 34 of the press-control mechanism 3.

The extending and retracting mechanism 2 comprises a slide 21, a limiter 22 and a spring member 23. The slide 21 is made of an elastically deformable material, comprising a base 211 having a through hole 2111, two arms 212 bilaterally backwardly extended from the base 211, a sliding slot 213 longitudinally located on each of the two arms 212 and having a rear stop edge 2131, a plurality of arched ribs 214 respectively transversely connected between the two arms 212 and an accommodation space 210 surrounded by the base 211, the arms 212 and the arched ribs 214 for accommodating the limiter 22. The limiter 22 comprises a sliding hole 221 longitudinally extending through the front and rear sides thereof, a flexible connection strip 222 extended from the front side of the peripheral wall thereof, a cover flap 223 connected to the free end of the flexible connection strip 222 and adapted for covering the front end of the sliding hole 221 and two stop blocks 224 bilaterally protruded from the periphery.

The press-control mechanism 3 comprises a cylindrical cap 31 defining therein an accommodation chamber 311, an absorption rod 32 tightly fitted into the accommodation chamber 311 of the cylindrical cap 31 and partially suspending outside the cylindrical cap 31, a pen clip 33 fastened to the cylindrical cap 31, and a strip spring 335. The pen clip 33 comprises a positioning protrusion 331 disposed near one end thereof, a press portion 332 disposed at the other end thereof, a connection lug 333 disposed between the positioning protrusion 331 and the press portion 332 corresponding to the protruding block 117 of the barrel 11, two locating blocks 3331 respectively extended from the connection lug 333 at two opposite lateral sides corresponding to the mounting holes 116 of the barrel 11, and a coupling tube 334 connected to the connection lug 333 and kept apart from the press portion 332. The coupling tube 334 has a locating groove 3341 located on the periphery and facing the press portion 332. The coupling tube 334 is insertable into the accommodation space 111 in the rear end portion 114 of the barrel 11, having a front stop edge 3342. The strip spring 335 is set in between the press portion 332 of the pen clip 33 and the coupling tube 334, having a mounting portion 3351 disposed at one end and fixedly fastened to the locating groove 3341 and a bearing portion 3352 disposed at the other end and stopped against the press portion 332 of the pen clip 33.

The assembly operation of the retractable push button pen is outlined hereinafter. The sprig member 23, limiter 22 and slide 21 of the extending and retracting mechanism 2 are sleeved onto the writing tip 122 of the pen refill 12 in proper order for enabling the limiter 22 and the spring member 23 to be accommodated in the accommodation space 210 inside the slide 21 and the two hooks 123 of the pen refill 12 to be received in the sliding slots 213 of the slide 21 and stopped at the rear stop edge 2131. Thereafter, the pen refill 12 is inserted with the attached slide 21, limiter 22 and sprig member 23 of the extending and retracting mechanism 2 into the accommodation space 111 in the rear end portion 114 of the barrel 11 to have the base 211 of the slide 21 be positioned in between the positioning ribs 113, the two arms 212 of the slide 21 be disposed at left and right sides relative to two positioning ribs 113 and the stop blocks 224 of the limiter 22 be stopped against the positioning ribs 113 so that the slide 21 forces the cover flap 223 to block the front end of the sliding hole 221 of the limiter 22. At this time, the writing tip 122 of the pen refill 12 is positioned in the sliding hole 221 of the limiter 22, and the beveled locating block 124 of the pen refill 12 is set in the sliding slot 115 of the barrel 11. Thereafter, the spring member 34 of the press-control mechanism 3 and the coupling tube 334 of the pen clip 33 are inserted in proper order into the accommodation space 111 in the rear end portion 114 of the barrel 11, for enabling the connection lug 333 of the pen clip 33 to be stopped against the protruding block 117 of the barrel 11 and the two locating blocks 3331 of the pen clip 33 to be respectively engaged into the mounting holes 116 of the barrel 11. At this time, the positioning protrusion 331 is inserted into the sliding slot 115 of the barrel 11, the front stop edge 3342 of the coupling tube 334 is stopped at one end of the spring member 34 against the beveled locating block 124 of the pen refill 12. Thereafter, the absorption rod 32 is inserted with the cylindrical cap 31 through the coupling tube 334 of the pen clip 33 inside the rear end portion 114 of the barrel 11. At this time, the cylindrical cap 31 is axially slidably supported in the coupling tube 334 of the pen clip 33 and partially extended out of the rear end portion 114 of the barrel 11, and the absorption rod 32 is inserted into the refill chamber 120 of the pen refill 12 and forced onto the rear plug end 1221 of the writing tip 122 in the refill chamber 120 of the refill body 121, for enabling the writing ink contained in the absorption rod 32 to be transferred to the writing tip 122 for writing. Thus, the retractable push button pen is assembled.

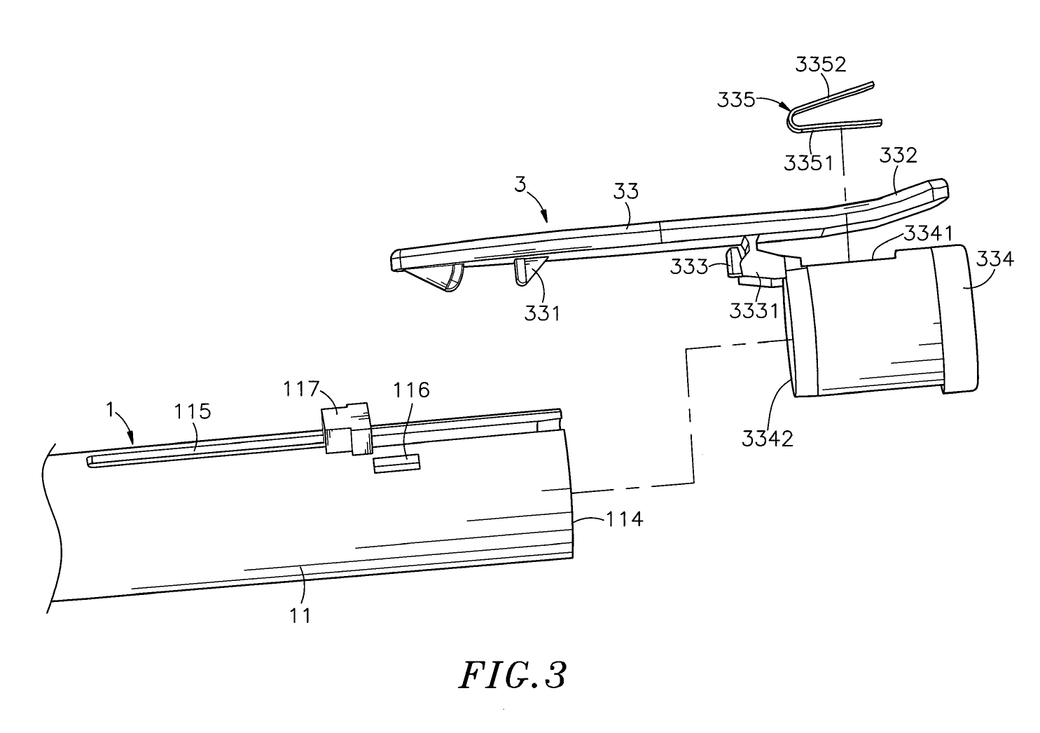

Referring to FIGS. 3˜7, when the user presses the cylindrical cap 31 of the press-control mechanism 3, the pen refill 12 will be forced forwards by the cylindrical cap 31 to carry the hooks 123 away from the rear stop edges 2131 of the sliding slots 213 of the slide 21, causing the front side of the refill body 121 to compress the spring member 23. Because the stop blocks 224 of the limiter 22 are stopped against the positioning ribs 113 of the barrel 11 and because the slide 21 is elastically deformable, the writing tip 122 is moved along the sliding hole 221 of the limiter 22 to push the cover flap 223 away from the front end of the sliding hole 221 when the cylindrical cap 31 is pressed by the user, and therefore the writing tip 122 can be further moved through the through hole 2111 of the base 211 of the slide 21 and the accommodation space 111 to the outside of the front end portion 112 of the barrel 11 of the pen body 1 for writing. When the pen refill 12 is moved forwards, the beveled locating block 124 is moved along the sliding slot 115 of the barrel 11 in direction away from the protruding block 117 toward the front end of the sliding slot 115. When the writing tip 122 is extended out of the front end portion 112 of the barrel 11, the beveled locating block 124 is moved over the positioning protrusion 331 of the pen clip 33 and stopped between the front end of the sliding slot 115 and the positioning protrusion 331 of the pen clip 33, thereby locking the writing tip 122 in the extended position for writing.

When wishing to retract the writing tip 122 inside the barrel 11, press the press portion 332 of the pen clip 33 against the bearing portion 3352 of the strip spring 335. Because the coupling tube 334 is supported on the periphery of the cylindrical cap 31 of the press-control mechanism 3, pressing the press portion 332 of the pen clip 33 causes the pen clip 33 to be biased to disengage the positioning protrusion 331 from the beveled locating block 124. Immediately upon disengagement of the positioning protrusion 331 from the beveled locating block 124, the spring member 23 pushes the refill body 121 of the pen refill 12 backwards, causing the pen refill 12 to carry the cylindrical cap 31 of the press-control mechanism 3 out of the rear end portion 114 of the barrel 11, and therefore the writing tip 122 is retracted inside the sliding hole 221 of the limiter 22 in the accommodation space 111 of the barrel 11. At this time, the elastically deformable slide 21 returns to its former shape and is moved backward relative to the limiter 22 by the hooks 123 of the pen refill 12, thereby forcing the cover flap 223 to close the front end of the sliding hole 221 again. When the user released the pressure from the press portion 332 of the pen clip 33 after retraction of the pen refill 12, the strip spring 335 returns the pen clip 33 to its former position, forcing the positioning protrusion 331 into the sliding slot 115 of the barrel 11 again. Thus, the user can operate the retractable push button pen with one single hand conveniently.

Further, when the pen refill 12 is returned to its former position to retract the writing tip 122 inside the barrel 11, the locating block 124 is forced against one end of the spring member 34, which has its other end stopped against the front stop edge 3342 of the coupling tube 334 of the pen clip 33. By means of buffering of the spring member 34 between the locating block 124 of the pen refill 12 and the coupling tube 334 of the pen clip 33, the locating block 124 is prohibited from striking against the connection lug 333 of the pen clip 33 during return stroke of the pen refill 12, avoiding noise or wear damage.

Further, the absorption rod 32 can be removed with the cylindrical cap 31 from the refill chamber 120 of the pen refill 12 and then inserted into an ink container (not shown) to absorb ink. Alternatively, the user can detach the used absorption rod 32 from the cylindrical cap 31 and attach a new replacement to the cylindrical cap 31, and then inserted with the cylindrical cap 31 into the refill chamber 120 to provide ink to the writing tip 122 for writing.

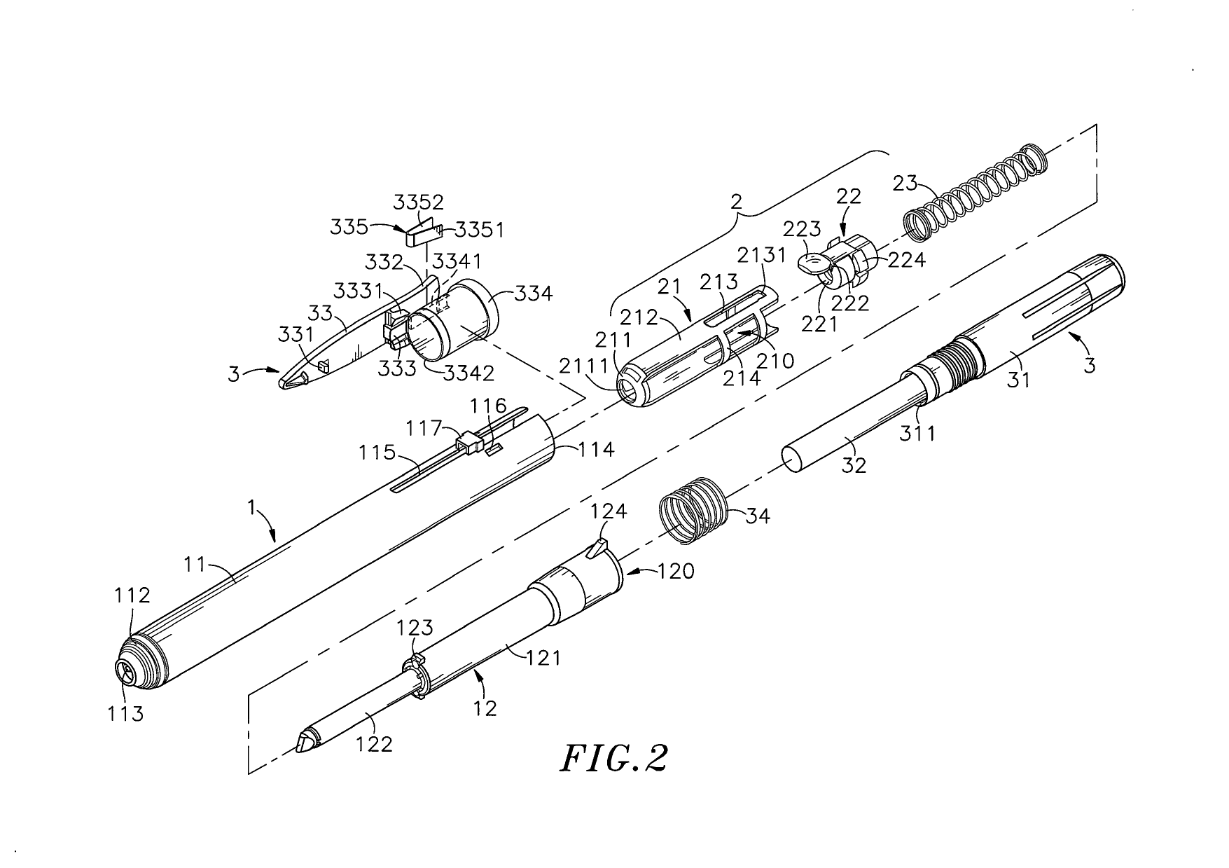

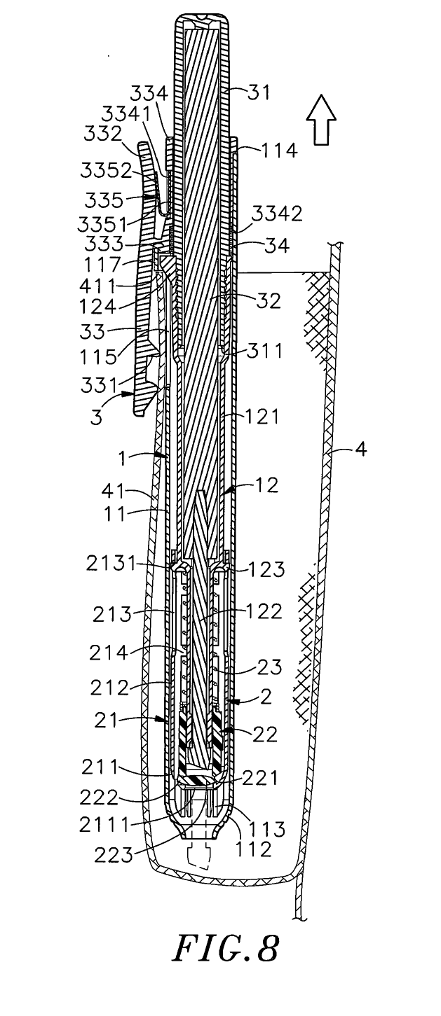

Referring to FIGS. 2 and 8, when the retractable push button pen is not in use, the user may put the retractable push button pen in the breast pocket 41 of his shirt 4 and fasten the pen clip 33 to the front panel 411 of the breast pocket 41. If the user forgets to retract the pen refill 12 inside the barrel 11, when putting the retractable push button pen in the breast pocket 41, the pen refill 12 will be retracted inside the barrel 11 automatically as the user presses the press portion 332 of the pen clip 33 to disengage the positioning protrusion 331 from the rear end portion 114 of the barrel 11 for enabling the pen clip 33 to be fastened to the front panel 411 of the breast pocket 41, avoiding direct contact between the writing tip 122 and the breast pocket 41 of the shirt 4. Therefore, the invention prevents the pen body 1 from contaminating the user's shirt 4.

In conclusion, the invention provides a retractable push button pen that has the following advantages and features:
1. The cylindrical cap 31 of the press-control mechanism 3 is provided at the rear side of the barrel 11 and pen refill 12 of the pen body 1 and operable to drive the extending and retracting mechanism 2 in the barrel 11, causing the writing tip 122 of the pen refill 12 to be moved out of the sliding hole 221 of the limiter 22 through the through hole 2111 of the slide 21 to the outside of the front end portion 112 of the barrel 11. When the writing tip 122 is extended out of the front end portion 112 of the barrel 11, the locating block 124 of the pen refill 12 is stopped between the front end of the sliding slot 115 and the positioning protrusion 331 of the pen clip 33, and therefore the writing tip 122 is locked in the extended position. When the user presses the press portion 332 of the pen clip 33 to disengage the positioning protrusion 331 from the locating block 124 of the pen refill 12, the spring member 23 immediately pushes the pen refill 12 backwards to have the writing tip 122 be received in the sliding hole 221 of the limiter 22 inside the barrel 11. Therefore, the user can operate the retractable push button pen with one single hand conveniently.
2. The stop blocks 224 of the limiter 22 are stopped against the positioning ribs 113 inside the front end portion 112 of the barrel 11. When the user presses the cylindrical cap 31 of the press-control mechanism 3 to move the pen refill 12 forwards, the writing tip 122 is moved along the sliding hole 221 of the limiter 22 to push the cover flap 223 away from the front end of the sliding hole 221, and therefore the writing tip 122 can be further moved to the outside of the front end portion 112 of the barrel 11 of the pen body 1 for writing. When the pen refill 12 is retracted to receive the writing tip 122 in the sliding hole 221 of the limiter 22, the slide 21 forces the cover flap 223 to block the front end of the sliding hole 221 of the limiter 22, avoiding direct contact of the writing tip 122 with the outside air. Therefore, the ink contained in the writing tip 122 will not be easily changed into vapor when the retractable push button pen is not used.
3. The extending and retracting mechanism 2 controls extending and retracting of the writing tip 122. Further, the cover flap 223 can be moved to close the sliding hole 221 of the limiter 22, avoiding direct contact of the writing tip 122 with the outside air. Because the extending and retracting mechanism 2 is mounted in the accommodation space 111 and stopped inside the barrel 11 by the press-control mechanism 3, no any external cover means is necessary to keep the extending and retracting mechanism 2 in place and the extending and retracting mechanism 2 will not fall out of the barrel 11.
4. During the assembly process of the present invention, the slide 21, limiter 22 and spring member 23 of the extending and retracting mechanism 2 are mounted on the front side of the pen refill 12, the absorption rod 32 and cylindrical cap 31 of the press-control mechanism 3 are mounted in the rear side of the pen refill 12, and then the pen refill 12 with the extending and retracting mechanism 2 and the press-control mechanism 3 are inserted into the accommodation space 111 of the barrel 11. Therefore, the assembly process of the retractable push button pen can be done conveniently and quickly.
5. Because the coupling tube 334 of the pen clip 33 is sleeved onto the cylindrical cap 31 of the press-control mechanism 3, frequently operating the press portion 332 does not cause disconnection of the pen clip 3 from the pen body 1. Further, the cylindrical cap 31 gives a support to the coupling tube 334 of the pen clip 33, and therefore the pen clip 33 will not be forced to vibrate when the user presses the press portion 332.
6. The invention has the strip spring 335 set between the press portion 332 and the coupling tube 334 so that the pen clip 33 is returned to its former position automatically when the applied pressure is released from the press portion 332.
7. The spring member 34 is stopped between the locating block 124 of the pen refill 12 and the front stop edge 3342 of the coupling tube 334 of the pen clip 33. By means of buffering of the spring member 34, the locating block 124 is prohibited from striking against the connection lug 333 of the pen clip 33 during return stroke of the pen refill 12, avoiding noise or wear damage.

A prototype of retractable push button pen has been constructed with the features of FIGS. 1˜8. The retractable push button pen functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A retractable push button pen, comprising:
a pen body, said pen body comprising:
a barrel, said barrel comprising an accommodation space longitudinally extending through front and rear ends thereof, a front end portion located on the front end, a plurality of positioning ribs located said front end portion, a rear end portion located on the rear end and a longitudinal sliding slot cut through the periphery of said rear end portion in communication with said accommodation space; and
a pen refill received in said accommodation space of said pen body, said pen refill comprising a refill body, said refill body having a front side and a rear side opposite to the front side, a refill chamber defined in said refill body, a writing tip, said writing tip having a rear plug end tightly inserted through the front side of said refill body into said refill chamber, two hooks bilaterally backwardly protruded from the periphery of the front side of said refill body and a beveled locating block protruded from the periphery of the rear side of said refill body;
an extending and retracting mechanism mounted around the writing tip of said pen refill, said extending and retracting mechanism comprising
a slide, said slide comprising a base having a through hole for the passing of said writing tip of said refill, two arms bilaterally backwardly extended from said base, a sliding slot longitudinally located on each of said two arms and respectively coupled to said hooks of said pen refill and an accommodation space surrounded by said base and said arms;
a limiter accommodated in the accommodation space in said slide, said limiter comprising a sliding hole longitudinally extending through front and rear sides thereof for the sliding of said writing tip of said pen refill, a cover flap adapted for closing and opening said sliding hole and a plurality of stop blocks protruded from the periphery thereof respectively stopped against the positioning ribs of said barrel; and
a spring member sleeved onto the writing tip of said pen refill and stopped between the rear side of said limiter and the hooks of said pen refill; and
a press-control mechanism mounted in the accommodation space inside the rear end portion of said barrel and operable to drive said extending and retracting mechanism in moving said pen refill between a received position and an extended position, said press-control mechanism comprising:
a cylindrical cap axially slidably inserted into the accommodation space in the rear end portion of said barrel and partially extending out of the rear end portion of said barrel, said cylindrical cap defining therein an accommodation chamber;
an absorption rod absorbing an ink, said absorption rod having a rear end tightly fitted into the accommodation chamber of said cylindrical cap and a front end suspending outside said cylindrical cap;
a pen clip, said pen clip comprising a positioning protrusion disposed near a front end thereof for engaging into the sliding slot of said barrel to stop said pen refill in said extended position, a press portion disposed at a rear end thereof for pressing by a person to disengage said positioning protrusion from the sliding slot of said barrel and a strip spring for returning said press portion.

2. The retractable push button pen as claimed in claim 1, wherein said pen clip further comprising a connection lug disposed between said positioning protrusion and said press portion and inserted through the sliding slot of said barrel, and a coupling tube connected to said connection lug and coupled to said cylindrical cap of said press-control mechanism in the accommodation space of said barrel.

3. The retractable push button pen as claimed in claim 2, wherein said coupling tube comprises a locating groove located on the periphery thereof; said strip spring comprises a mounting portion fastened to said locating groove of said coupling tube and a bearing portion stopped against said press portion of said pen clip.

4. The retractable push button pen as claimed in claim 2, wherein said barrel comprises two mounting holes disposed at two opposite sides relative to the sliding slot of said barrel; said pen clip further comprises two locating blocks bilaterally extended from said connection lug and respectively fastened to the mounting holes of said barrel.

5. The retractable push button pen as claimed in claim 2, wherein said press-control mechanism further comprising a spring member sleeved onto said cylindrical cap and stopped between the locating block of said pen refill and a front side of said coupling tube of said pen clip.

6. The retractable push button pen as claimed in claim 1, wherein said slide of said extending and retracting mechanism comprises a plurality of arched ribs respectively transversely connected between said two arms to support said two arms in place.

7. The retractable push button pen as claimed in claim 1, wherein each sliding slot of said slide has a stop edge at each of front and rear ends thereof for stopping hooks of said pen refill in one of said extended position and said received position.

8. The retractable push button pen as claimed in claim 1, wherein said limiter comprises a flexible connecting strip extended from the periphery thereof and connected with said cover flap for enabling said cover flap to be moved to close/open the sliding hole of said limiter.
